(19) United States
(12) Patent Application Publication
(10) Pub. No.: US 2024/0174885 A1
(43) Pub. Date: May 30, 2024

(54) Primer Coating Composition for Coating Laser Pattern, Coated Automotive Article Including the Same, and Method of Coating Automotive Part Using the Same

(71) Applicants: Hyundai Motor Company, Seoul (KE); Kia Corporation, Seoul (KR)

(72) Inventors: Sung Ho Park, Seoul (KR); Jong Yang Park, Cheonan-si (KR); Jae Won Kim, Uiwang-si (KR); Young Ho Jo, Gyeongsan-si (KR); Dong Woo Kim, Gyeongsan-si (KR)

(21) Appl. No.: 18/336,598

(22) Filed: Jun. 16, 2023

(30) Foreign Application Priority Data
Nov. 30, 2022 (KR) 10-2022-0163630

(51) Int. Cl. C09D 123/28; B05D 7/00; C09D 5/00; C09D 7/20; C09D 7/63; C09D 167/00; C09D 169/00

(52) U.S. Cl. CPC C09D 123/283; B05D 7/572; C09D 5/002; C09D 7/20; C09D 7/63; C09D 167/00; C09D 169/00

(57) ABSTRACT

An embodiment primer coating composition includes 20 to 25 wt % of a chlorinated polyolefin (CPO) resin having a weight-average molecular weight (Mw) of 50,000 to 100,000 g/mol, 2 to 4 wt % of a modified polyester, and 75 to 85 wt % of a hydrocarbon-based solvent. An embodiment coated automotive article includes a printing layer on a base layer, the printing layer including a laser pattern, a primer layer on the printing layer, the primer layer including a primer coating composition including 20 to 25 wt % of a chlorinated polyolefin (CPO) resin having a weight-average molecular weight (Mw) of 50,000 to 100,000 g/mol, 2 to 4 wt % of a modified polyester, and 75 to 85 wt % of a hydrocarbon-based solvent, and a clear layer on the primer layer.

### CROSS-REFERENCE TO RELATED APPLICATIONS

This application claims the benefit of Korean Patent Application No. 10-2022-0163630, filed on Nov. 30, 2022, which application is hereby incorporated herein by reference.

### TECHNICAL FIELD

The present disclosure relates to a primer coating composition.

### BACKGROUND

In automobiles, a coating treatment is performed with respect to some products, among molded members for automobiles applied to the interior parts or exterior parts of the automobiles, so as to implement surface hardening for corrosion prevention (corrosion resistance) or plating decoration design having a luxurious image.

Particularly, coating of extruded members applied to the exterior parts of the automobiles may be performed so as to form a basic structure in which a binder layer, a coating layer including a color paint, and a clear layer are sequentially stacked on a base layer.

Here, the binder layer may be a layer configured to enable adhesion of the coating layer to the base layer, and the clear layer may be a transparent layer configured to protect the coating layer.

In the extruded members applied to the exterior parts of the automobiles, such as lamps, bumpers, hoods, fenders, trunks, etc., surface treatment may be performed between the coating layer and the clear layer so as to form a laser pattern having light emitting panels.

After the coating layer has been surface-treated to form the laser pattern thereon, an annealing process is performed at a high temperature so as to secure clearness of the design of the pattern. However, the annealing process performed at the high temperature causes decreased adhesion between the laser pattern and the coating layer and the clear layer due to over-drying.

Therefore, under the above background, a method of coating an extruded member applied to an exterior part of an automobile, which may increase laser processability of a coating film, may secure clearness of a laser pattern design, and may improve adhesion between a coating layer and a clear layer, is required.

The above information disclosed in this background section is only for enhancement of understanding of the background of embodiments of the invention and therefore it may contain information that does not form the prior art that is already known to a person of ordinary skill in the art.

### SUMMARY

The present disclosure relates to a primer coating composition. Particular embodiments relate to a primer coating composition for coating a laser pattern, a coated automotive article including the same, and a method of coating an automotive part using the same.

Embodiments of the present invention can solve problems associated with the prior art, and an embodiment of the present invention provides a primer coating composition which may secure clearness of a laser pattern design and may improve adhesion between a coating layer and a clear layer, a coated automotive article including the same, and a method of coating an automotive part using the same.

One embodiment of the present invention provides a primer coating composition including 20 to 25 wt % of a chlorinated polyolefin (CPO) resin having a weight-average molecular weight (Mw) of 50,000 to 100,000 g/mol, 2 to 4 wt % of a modified polyester, and 75 to 85 wt % of a hydrocarbon-based solvent.

In a preferred embodiment, the chlorinated polyolefin (CPO) resin may have a non-volatile (NV) content of 15 to 25 wt %.

In another preferred embodiment, the modified polyester may have a non-volatile (NV) content of 50 to 70 wt % and may have a glass transition temperature (Tg) of 10 to 30° C.

Another embodiment of the present invention provides a coated automotive article including a printing layer located on a base layer and including a laser pattern, a primer layer located on the printing layer and including a primer coating composition, and a clear layer located on the primer layer, wherein the primer coating composition includes 20 to 25 wt % of a chlorinated polyolefin (CPO) resin having a weight-average molecular weight (Mw) of 50,000 to 100,000 g/mol, 2 to 4 wt % of a modified polyester, and 75 to 85 wt % of a hydrocarbon-based solvent.

In a preferred embodiment, the base layer may include a polycarbonate (PC) material.

Another embodiment of the present invention provides a method of coating an automotive part including sequentially coating a base layer with a binder layer and a coating layer, primarily heat-treating the coated base layer, forming a printing layer including a laser pattern on the base layer, secondarily heat-treating the printing layer, sequentially coating the printing layer with a primer layer including a primer coating composition and a clear layer, and tertiarily heat-treating the coated printing layer, wherein the primer coating composition includes 20 to 25 wt % of a chlorinated polyolefin (CPO) resin having a weight-average molecular weight (Mw) of 50,000 to 100,000 g/mol, 2 to 4 wt % of a modified polyester, and 75 to 85 wt % of a hydrocarbon-based solvent.

In a preferred embodiment, the binder layer may include a main agent part including at least one selected from the group consisting of an acryl polyol, carbon black, a dispersant, a leveling agent, a wetting agent, a UV absorber, a catalyst, a ketone-based solvent, an ester-based solvent, and combinations thereof, and a hardening agent part including hexamethylene diisocyanate trimer and an ester-based solvent.

In another preferred embodiment, the main agent part and the hardening agent part of the binder layer may be mixed in a weight ratio of 5-10:1.

In still another preferred embodiment, the coating layer may include a main agent part including a color paint and a hardening agent part including hexamethylene diisocyanate trimer and an ester-based solvent.

In yet another preferred embodiment, the main agent part and the hardening agent part of the coating layer may be mixed in a weight ratio of 5-10:1.

In still yet another preferred embodiment, sequentially coating the base layer with the binder layer and the coating layer may include applying the binder layer to a thickness of 8 to 10 μm and applying the coating layer to a thickness of 10 to 15 μm.

In a further preferred embodiment, primarily heat-treating the coated base layer may be performed at a temperature of 70 to 90° C. for 20 to 60 minutes.

In another further preferred embodiment, the clear layer may include a main agent part including at least one selected from the group consisting of an acryl polyol, a catalyst, a leveling agent, a wetting agent, a UV absorber, an ester-based solvent, a ketone-based solvent, a hydrocarbon-based solvent, a polyhydric alcohol derivative solvent, and combinations thereof, and a hardening agent part including hexamethylene diisocyanate trimer and an ester-based solvent.

In still another further preferred embodiment, the main agent part and the hardening agent part of the clear layer may be mixed in a weight ratio of 2-5:1.

In yet another further preferred embodiment, secondarily heat-treating the printing layer may be performed at a temperature of 110 to 140° C. for 30 to 60 minutes.

In still yet another further preferred embodiment, sequentially coating the printing layer with the primer layer and the clear layer may include applying the primer layer to a thickness of 4 to 6 μm and applying the clear layer to a thickness of 28 to 38 μm.

In a still further preferred embodiment, tertiarily heat-treating the coated printing layer may be performed at a temperature of 70 to 90° C. for 20 to 60 minutes.

Other aspects and preferred embodiments of the invention are discussed infra.

The above and other features of embodiments of the invention are discussed infra.

### BRIEF DESCRIPTION OF THE DRAWINGS

The above and other features of embodiments of the present invention will now be described in detail with reference to certain exemplary embodiments thereof illustrated in the accompanying drawings which are given hereinbelow by way of illustration only, and thus are not limitative of the present invention, and wherein:

FIG. 1 is a schematic longitudinal-sectional view of a coated automotive article according to embodiments of the present invention;

FIG. 2 is a flowchart representing a method of coating an automotive part according to embodiments of the present invention;

FIGS. 3A and 3B are longitudinal-sectional views schematically showing a process of forming a printing layer including a laser pattern; and

FIG. 4 is a table representing results of reliability tests for coated automotive articles according to embodiments of the present invention.

It should be understood that the appended drawings are not necessarily to scale, presenting a somewhat simplified representation of various preferred features illustrative of the basic principles of embodiments of the invention. The specific design features of embodiments of the present invention as disclosed herein, including, for example, specific dimensions, orientations, locations, and shapes, will be determined in part by the particular intended application and use environment.

In the figures, reference numbers refer to the same or equivalent parts of embodiments of the present invention throughout the several figures of the drawings.

### DETAILED DESCRIPTION OF ILLUSTRATIVE EMBODIMENTS

The above-described objects, other objects, advantages, and features of embodiments of the present invention will become apparent from the descriptions of preferred embodiments given hereinbelow with reference to the accompanying drawings. However, the present invention is not limited to the embodiments disclosed herein and may be implemented in various different forms. The embodiments are provided to make the description of the present invention thorough and to fully convey the scope of the present invention to those skilled in the art.

In the following description of the embodiments, terms such as “including”, “comprising”, and “having” are to be interpreted as indicating the presence of characteristics, numbers, steps, operations, elements, or parts stated in the description or combinations thereof, and do not exclude the presence of one or more other characteristics, numbers, steps, operations, elements, parts, or combinations thereof, or the possibility of adding the same. In addition, it will be understood that when a part, such as a layer, a film, a region, or a plate, is said to be “on” another part, the part may be located “directly on” the other part or other parts may be interposed between the two parts. In the same manner, it will be understood that when a part, such as a layer, a film, a region, or a plate, is said to be “under” another part, the part may be located “directly under” the other part or other parts may be interposed between the two parts.

Embodiments of the present invention relate to a primer coating composition for coating a laser pattern, a coated automotive article including the same, and a method of coating an automotive part using the same.

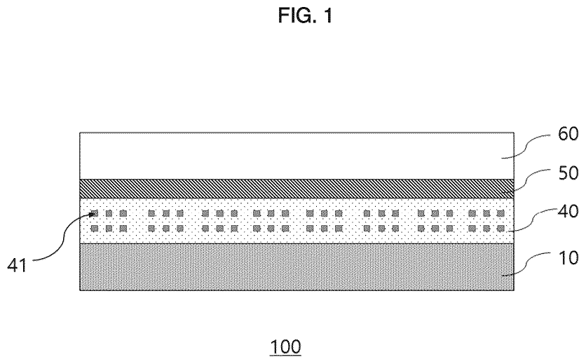

Hereinafter, embodiments of the present invention will be described in more detail with reference to the accompanying drawings. FIG. 1 is a schematic longitudinal-sectional view of a coated automotive article according to embodiments of the present invention.

Referring to FIG. 1, a coated automotive article 100 according to embodiments of the present invention includes a printing layer 40 located on a base layer 10 and including a laser pattern 41, a primer layer 50 located on the printing layer 40 and including a primer coating composition, and a clear layer 60 located on the primer layer 50.

The primer coating composition includes 20 to 25 wt % of a chlorinated polyolefin (CPO) resin having a weight-average molecular weight (Mw) of 50,000 to 100,000 g/mol, 2 to 4 wt % of a modified polyester, and 75 to 85 wt % of a hydrocarbon-based solvent.

Concretely, the coated automotive article 100 may have a structure in which the base layer 10, the printing layer 40, the primer layer 50, and the clear layer 60 are sequentially stacked.

### Base Layer

The base layer 10 is a layer which is provided for a coating layer 30 to be applied thereto and may be located at the lowermost position.

The base layer 10 may be formed of a material having transparency to a thickness of 0.1 to 1 mm, without being limited thereto. The base layer 10 may include at least one selected from the group consisting of a polycarbonate (PC) film, a poly(methyl methacrylate) (PMMA) film, a coextruded PC/PMMA film, and a polyethylene terephthalate (PET) film.

Concretely, the base layer 10 may employ a transparent polycarbonate (PC) material.

### Printing Layer

The printing layer 40 is a layer which is coated with the primer layer 50 and may be located between the base layer 10 and the primer layer 50.

The printing layer 40 may include light sources, such as light emitting panels. In the printing layer 40, the light sources may be arranged to form the laser pattern 41.

In the coated automotive article 100 according to embodiments of the present invention, the printing layer 40 may be formed by surface-treating the base layer 10, which is sequentially coated with a binder layer 20 and the coating layer 30, so as to form the laser pattern 41 on the base layer 10. Therefore, the printing layer 40 according to embodiments of the present invention includes the laser pattern 41.

### Primer Layer

The primer layer 50 is a layer which is provided to adhere the printing layer 40 and the clear layer 60 to each other and may be located on the printing layer 40. The primer layer 50 may be a transparent layer.

The primer layer 50 includes the primer coating composition.

The primer coating composition according to embodiments of the present invention includes 20 to 25 wt % of the chlorinated polyolefin (CPO) resin having a weight-average molecular weight (Mw) of 50,000 to 100,000 g/mol, 2 to 4 wt % of the modified polyester, and 75 to 85 wt % of the hydrocarbon-based solvent.

Particularly, in embodiments of the present invention, the CPO resin including Cl having a low molecular weight is used to improve adhesive power.

The molecular weight of the CPO resin may be 50,000 to 100,000 g/mol.

The primer coating composition may include 20 wt % of the chlorinated polyolefin (CPO) resin having excellent adhesive power as a main resin and may thus provide adhesive power to a surface to which another layer is difficult to adhere, such as the surface of a base layer formed of overdried acrylic urethane, and may include 3 wt % of the modified polyester having compatibility with acrylic resins of the coating layer 30 and the clear layer 60 and may thus increase adhesive power between these layers 30 and 60.

The chlorinated polyolefin (CPO) resin may have a non-volatile (NV) content of 15 to 25 wt %.

The modified polyester may have a non-volatile (NV) content of 50 to 70 wt % and may have a glass transition temperature (Tg) of 10 to 30° C.

### Clear Layer

The clear layer 60 is a layer which is located at the outermost position of the coated automotive article 100 and may be located on the primer layer 50.

The clear layer 60 may be a transparent layer configured to protect the printing layer 40.

The clear layer 60 may include a main agent part including at least one selected from the group consisting of an acryl polyol, a catalyst, a leveling agent, a wetting agent, a UV absorber, an ester-based solvent, a ketone-based solvent, a hydrocarbon-based solvent, a polyhydric alcohol derivative solvent, and combinations thereof, and a hardening agent part including hexamethylene diisocyanate trimer and an ester-based solvent.

The main agent part of the clear layer 60 may include 60 to 80 wt % of the acryl polyol, 0.01 to 0.1 wt % of the catalyst, 0.1 to 0.5 wt % of the leveling agent, 0.1 to 0.5 wt % of the wetting agent, 1 to 3 wt % of the UV absorber, 1 to 10 wt % of the ester-based solvent, 1 to 5 wt % of the ketone-based solvent, 10 to 15 wt % of the hydrocarbon-based solvent, and 0.5 to 2 wt % of the polyhydric alcohol derivative solvent. Further, the hardening agent part of the clear layer 60 may include 40 to 60 wt % of hexamethylene diisocyanate trimer and 40 to 60 wt % of the ester-based solvent.

In the clear layer 60 according to embodiments of the present invention, the main agent part and the hardening agent part may be mixed in a weight ratio of 2-5:1.

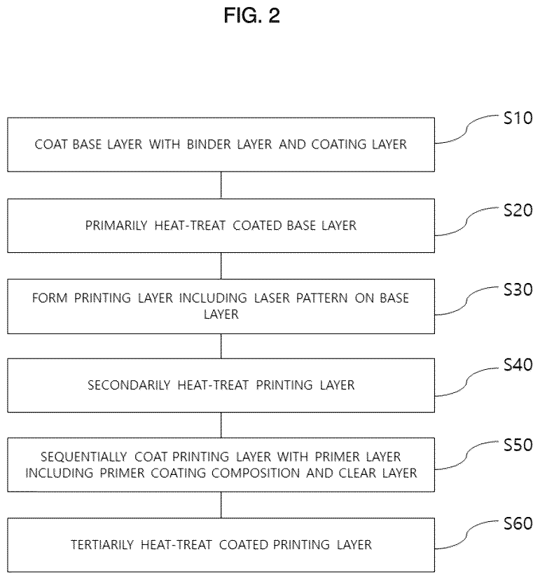

Another embodiment of the present invention relates to a method of coating an automotive part. Hereinafter, embodiments of the present invention will be described in more detail with reference to FIG. 2.

Prior to the description of the above method, the base layer, the printing layer, the primer layer, and the clear layer used in the method have been described above, and a detailed description thereof will thus be omitted.

FIG. 2 is a flowchart representing the method of coating the automotive part according to embodiments of the present invention.

The method of coating the automotive part according to embodiments of the present invention includes sequentially coating the base layer with the binder layer and the coating layer (S10), primarily heat-treating the coated base layer (S20), forming the printing layer including the laser pattern on the base layer (S30), secondarily heat-treating the printing layer (S40), sequentially coating the printing layer with the primer layer including the primer coating composition and the clear layer (S50), and tertiarily heat-treating the coated printing layer (S60). Here, the primer coating composition according to embodiments of the present invention includes 20 to 25 wt % of the chlorinated polyolefin (CPO) resin having a weight-average molecular weight (Mw) of 50,000 to 100,000 g/mol, 2 to 4 wt % of the modified polyester, and 75 to 85 wt % of the hydrocarbon-based solvent.

Hereinafter, the respective operations of the method according to embodiments of the present invention will be descried in detail.

First, in step S10, the base layer is sequentially coated with the binder layer and the coating layer.

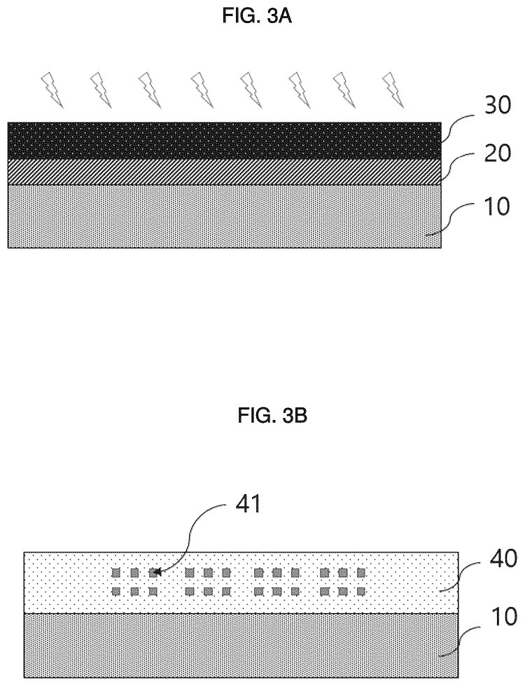

FIG. 3A schematically shows the base layer 10 before formation of the printing layer 40 including the laser pattern 41.

Referring to FIG. 3A, the binder layer 20 may be applied to the base layer 10.

The binder layer 20 may be applied to a thickness of 8 to 10 μm. Here, the binder layer 20 may be applied using any application method that is commonly used in the technical field to which the invention pertains, without being limited thereto.

The binder layer 20 is a layer which is provided to adhere the base layer 10 and the coating layer 30 to each other and may be located on the base layer 10.

The binder layer 20 may include a main agent part including at least one selected from the group consisting of an acryl polyol, carbon black, a dispersant, a leveling agent, a wetting agent, a UV absorber, a catalyst, a ketone-based solvent, an ester-based solvent, and combinations thereof, and a hardening agent part including hexamethylene diisocyanate trimer and an ester-based solvent.

Concretely, the main agent part of the binder layer 20 may include 65 to 70 wt % of the acryl polyol, 3 to 5 wt % of carbon black, 0.1 to 1 wt % of the dispersant, 0.1 to 0.5 wt % of the leveling agent, 0.1 to 0.5 wt % of the wetting agent, 0.1 to 1 wt % of the UV absorber, 0.01 to 0.1 wt % of the catalyst, 10 to 20 wt % of the ketone-based solvent, and 10 to 20 wt % of the ester-based solvent. Further, the hardening agent part of the binder layer 20 may include 40 to 60 wt % of hexamethylene diisocyanate trimer and 40 to 60 wt % of the ester-based solvent.

In the binder layer 20 according to embodiments of the present invention, the main agent part and the hardening agent part may be mixed in a weight ratio of 5-10:1.

Thereafter, the coating layer 30 may be applied to the binder layer 20. The coating layer 30 may be applied to a thickness of 10 to 15 μm. Here, the coating layer 30 may be applied using any application method that is commonly used in the technical field to which the invention pertains, without being limited thereto.

The coating layer 30 is a layer which implements the overall color of the coated automotive article 100 and may be located on the binder layer 20.

The coating layer 30 may include a main agent part including a color paint and a hardening agent part including hexamethylene diisocyanate trimer and an ester-based solvent.

The color paint may include one selected from the group consisting of a urethane-based ink, a polyvinyl chloride-based ink, and a combination thereof, without being limited thereto. Further, the hardening agent part of the coating layer 30 may include 40 to 60 wt % of hexamethylene diisocyanate trimer and 40 to 60 wt % of the ester-based solvent.

In the coating layer 30 according to embodiments of the present invention, the main agent part and the hardening agent part may be mixed in a weight ratio of 5-10:1.

Thereafter, in step S20, the base layer 10 coated with the binder layer 20 and the coating layer 30 is primarily heat-treated. In step 20, the primary heat treatment may be performed at a temperature of 70 to 90° C. for 20 to 60 minutes.

Thereafter, in step S30, the printing layer 40 including the laser pattern 41 is formed on the base layer 10.

FIG. 3B schematically shows the printing layer 40 having the laser pattern 41 formed on the base layer 10.

Referring to FIG. 3B, the printing layer 40 may include light sources, such as light emitting panels. In the printing layer 40, the light sources may be arranged to form the laser pattern 41.

In step S30, the laser pattern 41 of the printing layer 40 may be formed by surface-treating the base layer 10 sequentially coated with the binder layer 20 and the coating layer 30.

Thereafter, in step S40, the printing layer 40 is secondarily heat-treated.

In step S40, the secondary heat treatment may be performed at a temperature of 110 to 140° C. for 30 to 60 minutes.

In embodiments of the present invention, the secondary heat treatment indicates an annealing process.

The annealing process is a process of softening a metal by exposing the metal at a high temperature of equal to or higher than a recrystallization temperature for a long time.

Thereafter, in step S50, the printing layer 40 is sequentially coated with the primer layer and the clear layer.

The primer layer includes the primer coating composition, and more specifically, 20 to 25 wt % of the chlorinated polyolefin (CPO) resin having a weight-average molecular weight (Mw) of 50,000 to 100,000 g/mol, 2 to 4 wt % of the modified polyester, and 75 to 85 wt % of the hydrocarbon-based solvent.

In step S50, the primer layer may be applied to the printing layer 40 to a thickness of 4 to 6 μm, and the clear layer may be applied to the primer layer to a thickness of 28 to 38 μm. Here, the primer layer and the clear layer may be applied using any application method that is commonly used in the technical field to which the invention pertains, without being limited thereto.

Finally, in step S60, the printing layer 40 coated with the primer layer and the clear layer is tertiarily heat-treated, and coating of the automotive part is completed. In step S60, the tertiary heat treatment may be performed at a temperature of 70 to 90° C. for 20 to 60 minutes.

Hereinafter, embodiments of the present invention will be described in more detail through the following examples. The following examples serve merely to exemplarily describe embodiments of the present invention and are not intended to limit the scope of the invention.

### EXAMPLES

First, a coated article was manufactured by performing coating according to Example 1 using process conditions set forth in Table 1 below. In Example 1, a primer layer is applied between a printing layer and a clear layer. Here, the components and properties of a binder layer, a coating layer, the printing layer, the primer layer, and the clear layer, which were used, are as follows.

### 1). Binder Layer

The main agent of the binder layer included 68 wt % of an acrylic polyol, 3.5 wt % of a carbon black pigment, 0.5 wt % of a dispersant, 15 wt % of a ketone-based solvent, 11.65 wt % of an ester-based solvent, 0.15 wt % of a leveling agent, 0.65 wt % of a wetting agent, 0.5 wt % of a UV absorber, and 0.05 wt % of a catalyst.

The main agent had a particle size of equal to or less than 10 μm through dispersion and was mixed with a hardening agent using a quick-drying thinner and a slow-drying thinner blended in a proper composition ratio thereto.

The hardening agent included 50 wt % of Tolonate™ HDT and 50 wt % of an ester-based solvent, and the main agent and the hardening agent were mixed at a weight ratio of 14:1.

### 2). Coating Layer

The main agent of the coating layer included a color paint.

The hardening agent of the coating layer included 50 wt % of Tolonate™ HDT and 50 wt % of an ester-based solvent, and the main agent and the hardening agent were mixed at a weight ratio of 13:1.

### 3). Primer Layer

The primer layer included a composition including 20 wt % of a CPO resin, 80 wt % of a hydrocarbon-based solvent, and 3 wt % of a modified polyester resin.

The molecular weight of the CPO resin was 50,000 to 100,000 g/mol, and the non-volatile (NV) content of the CPO resin was 20 wt %.

The non-volatile (NV) content of the modified polyester resin was 60 wt %, and the glass transition temperature (Tg) of the modified polyester resin was 20° C.

### 4). Clear Layer

The main agent of the clear layer 60 included 72 wt % of an acryl polyol, 6 wt % of an ester-based solvent, 4 wt % of a ketone-based solvent, 0.15 wt % of a catalyst, 0.3 wt % of a leveling agent, 0.3 wt % of a wetting agent, 2 wt % of a UV absorber, 14.25 wt % of a hydrocarbon-based solvent, and 1 wt % of a polyhydric alcohol derivative solvent.

The hardening agent of the clear layer included 50 wt % of Tolonate™ HDT and 50 wt % of an ester-based solvent, and the main agent and the hardening agent were mixed at a weight ratio of 5.4:1.

### COMPARATIVE EXAMPLES

A coated article according to Comparative Example 1 was manufactured in the same manner as in Example 1, except that the primer layer was not used.

A coated article according to Comparative Example 2 (i.e., a conventional coated article) was manufactured in the same manner as in Example 1, except that, among the components of the primer layer of Example 1, the modified polyester resin was not used.

### Test Example 1

Thereafter, the properties of the coated articles were measured by methods set forth in Table 1, and the measured properties are set forth in Table 1.

TABLE 1

| | | | | Comp. | | | |
|---|---|---|---|---|---|---|---|
| | | Comp. | | Example 2 | | | |
| Category | | Example 1 | | (conventional) | | Example 1 | |
| Coating | — | Thickness | | Thickness | | Thickness | |
| conditions | | | | | | | |
| Material | Base layer | Transparent | | Transparent | | Transparent | |
| | | PC material | | PC material | | PC material | |
| Pre- | — | Degreasing | | Degreasing | | Degreasing | |
| treatment | | using IPA | | using IPA | | using IPA | |
| Primary | Binder layer | 8-10 | μm | 8-10 | μm | 8-10 | μm |
| coating | | | | | | | |
| Flash-off- | — | 5-10 | minutes | 5-10 | minutes | 5-10 | minutes |
| time | | | | | | | |
| Secondary | Coating layer/color | 10-15 | μm | 10-15 | μm | 10-15 | μm |
| coating | paint (black pearl, red | | | | | | |
| | pearl, blue pearl, white | | | | | | |
| | pearl) | | | | | | |
| Flash-off- | — | 5-10 | minutes | 5-10 | minutes | 5-10 | minutes |
| time | | | | | | | |
| Primary | — | 80° C. × 30 | | 80° C. × 30 | | 80° C. × 30 | |
| baking | | minutes | | minutes | | minutes | |
| Laser | Printing layer | Surface laser | | Surface laser | | Surface laser | |
| patterning | | patterning | | patterning | | patterning | |
| treatment | | | | | | | |
| Secondary | Annealing process | 120° C. × 40 | | 120° C. × 40 | | 120° C. × 40 | |
| baking | | minutes | | minutes | | minutes | |
| Pre- | — | Degreasing | | Degreasing | | Degreasing | |
| treatment | | using IPA | | using IPA | | using IPA | |
| Tertiary | Primer layer | Non-coating | | 4-6 | μm | 4-6 | μm |
| coating | | | | | | | |
| Flash-off- | — | 5-10 | minutes | 5-10 | minutes | 5-10 | minutes |
| time | | | | | | | |
| Quaternary | Clear layer | 28-38 | μm | 28-38 | μm | 28-38 | μm |
| coating | | | | | | | |
| Flash-off- | — | 5-10 | minutes | 5-10 | minutes | 5-10 | minutes |
| time | | | | | | | |

| | | | | |
|---|---|---|---|---|
| Tertiary | — | 80° C. × 30 | | 80° C. × 30 |
| baking | | minutes | | minutes |
| Reliability | Initial adhesion | OK (M-1.5) | OK (M-1.5) | OK (M-1.0) |
| result of | * Water resistant | NG (M-5.0) | OK (M-1.5) | OK (M-1.0) |
| coating film | adhesion (40° C. × 240 | | | |
| * MS210-14 | hr)-M should be equal | | | |
| TypeB-1, | to or less than 2.5 | | | |
| ** MS655-08 | ** Heat resistant | NG (M-5.0) | NG (M-3.5) | OK (M-1.0) |
| | adhesion (80° C. × 300 | | | |
| | hr)-M of equal to or less | | | |
| | than 2.5 | | | |
| | * Heat resistant | — | — | OK (M-1.0) |
| | adhesion (110° C. × 300 | | | |
| | hr) | | | |
| | * High-pressure car | NG (100/100) | NG (4-35/100) | OK (1/100) |
| | wash (70 bar) | | | |

Referring to Table 1, it may be confirmed that the coated article according to Comparative Example 1, in which the primer layer was not used, exhibited poor adhesion in MS specifications.

Further, it may be confirmed that the coated article according to Comparative Example 2, in which the modified polyester resin is not used as a component of the primer layer, exhibited poor adhesion compared to the coated article according to Example 1. Therefore, in the coated articles according to Comparative Examples 1 and 2, adhesion between the printing layer and the clear layer was not good.

On the other hand, the coated article according to Example 1 exhibited improved adhesion using the primer layer including the modified polyester resin and the CPO resin, which were properly mixed, and thus showed satisfactory results in the MS specifications.

Therefore, as results of the tests, it may be confirmed that adhesion is improved using a proper content of the modified polyester.

Accordingly, in embodiments of the present invention, the transparent primer layer is applied between the coating layer and the clear layer so as to increase adhesion between the printing layer and the clear layer, which was deteriorated due to over-drying after the annealing process.

### Test Example 2

Next, coated articles were manufactured by performing a coating process using the main agent of the coating layer according to Example 1 by employing respective color paints set forth in Table 2 below.

TABLE 2

| No. | Color | Main agent product name |
|---|---|---|
| 1 | White pearl | KAR U/B white pearl color paint |
| (Example 5) | | KAR U/B white pearl paint |
| 2 | Black pearl | KAR U/B black pearl paint |
| (Example 2) | | |
| 3 | Red pearl | KAR U/B red pearl paint |
| (Example 4) | | |
| 4 | Blue pearl | KAR U/B blue pearl paint |
| (Example 3) | | |

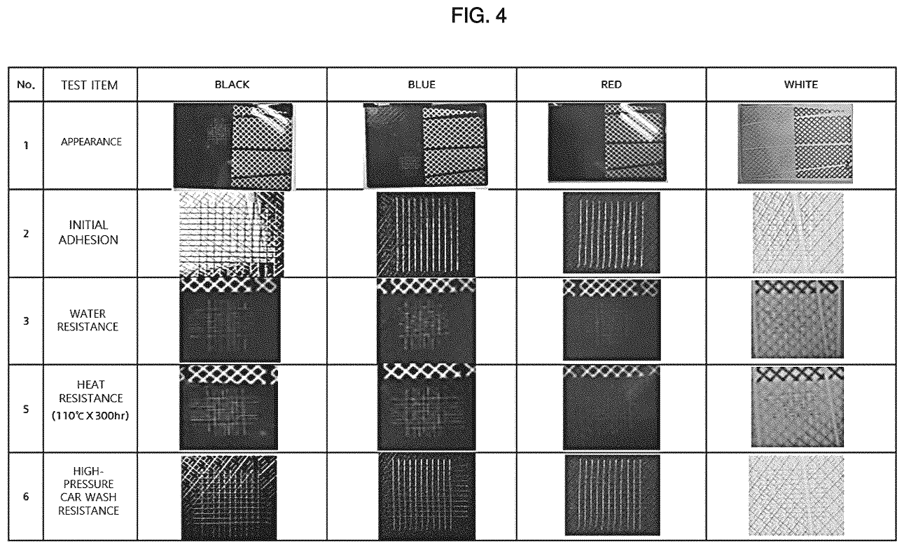

Thereafter, the properties of the coated articles were measured, and the measured properties are set forth in Table 3 and FIG. 4. FIG. 4 represents results of reliability tests for the coated articles according to embodiments of the present invention.

TABLE 3

| | | | Pass/fail | | | | | |
|---|---|---|---|---|---|---|---|---|
| | Evaluation | Evaluation | determination | | Example | Example | Example | Example |
| No. | item | conditions | criterion | | 2 | 3 | 4 | 5 |
| 1 | Color | — | — | | Black | Blue | Red | White |
| 2 | Appearance | — | — | Should | OK | OK | OK | OK |
| | | | | have no | | | | |
| | | | | problem | | | | |
| 3 | Initial | — | — | M-2.5 | OK | OK | OK | OK |
| | adhesion | | | or less | (M-1.0) | (M-1.0) | (M-1.0) | (M-1.0) |
| 4 | Water | 40° C. × | Appearance | Should | OK | OK | OK | OK |
| | resistance | 240 hr | | have no | | | | |
| | | | | problem | | | | |
| | | | Adhesion | M-2.5 | OK | OK | OK | OK |
| | | | | or less | (M-1.0) | (M-1.0) | (M-1.0) | (M-1.0) |
| | | | Color | 3.0 or | OK | OK | OK | OK |
| | | | difference | less ** | | | | |
| | | | | 2.0 or | | | | |
| | | | | less * | | | | |
| | | | Gray scale | Level 4 | OK | OK | OK | OK |
| | | | | or more * | | | | |
| | | | | Level 3 | | | | |
| | | | | or more ** | | | | |
| 5 | Heat | 110° C. × | Appearance | Should | OK | OK | OK | OK |
| | resistance | 300 hr (*) | | have no | | | | |
| | | | | problem | | | | |
| | | | Adhesion | M-2.5 | OK | OK | OK | OK |
| | | | | or less | (M-1.0) | (M-1.0) | (M-1.0) | (M-1.0) |
| | | | Color | 3.0 or | OK | OK | OK | OK |
| | | | difference | less ** | | | | |
| | | | | 2.0 or | | | | |
| | | | | less * | | | | |
| | | | Gray scale | Level 4 | OK | OK | OK | OK |
| | | | | or more * | | | | |
| | | | | Level 3 | | | | |
| | | | | or more ** | | | | |
| 6 | High- | 70 bar | *Should | | OK | OK | OK | OK |
| | pressure | | not be | | (0/100) | (0/100) | (0/100) | (0/100) |
| | car wash | | peeled off | | | | | |
| | resistance | | | | | | | |

Referring to Table 3 and FIG. 4, as results of the tests, the coated articles according to embodiments of the present invention exhibited water resistant adhesion and heat resistant adhesion, which satisfy the MS specifications, and good results in both initial adhesion and high-pressure car wash resistance.

Therefore, the coated automotive article according to embodiments of the present invention employs the primer layer including the primer coating composition, and may thus increase adhesion between the coating layer and the clear layer, which was deteriorated by annealing after formation of the laser pattern.

Further, the primer coating composition according to embodiments of the present invention may use any paints that are currently used in exterior parts of automobiles and may thus be well matched with a body color.

As is apparent from the above description, a coated automotive article according to embodiments of the present invention employs a primer layer including a primer coating composition, and may thus increase adhesion between a coating layer and a clear layer, which was deteriorated by annealing after formation of a laser pattern.

Embodiments of the invention have been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A primer coating composition comprising:
20 to 25 wt % of a chlorinated polyolefin (CPO) resin having a weight-average molecular weight (Mw) of 50,000 to 100,000 g/mol;
2 to 4 wt % of a modified polyester; and
75 to 85 wt % of a hydrocarbon-based solvent.

2. The primer coating composition of claim 1, wherein the chlorinated polyolefin (CPO) resin comprises a non-volatile (NV) content of 15 to 25 wt %.

3. The primer coating composition of claim 1, wherein the modified polyester comprises a non-volatile (NV) content of 50 to 70 wt % and has a glass transition temperature (Tg) of 10 to 30° C.

4. A coated automotive article comprising:
a printing layer on a base layer, the printing layer comprising a laser pattern;
a primer layer on the printing layer, the primer layer comprising a primer coating composition comprising 20 to 25 wt % of a chlorinated polyolefin (CPO) resin having a weight-average molecular weight (Mw) of 50,000 to 100,000 g/mol, 2 to 4 wt % of a modified polyester, and 75 to 85 wt % of a hydrocarbon-based solvent; and
a clear layer on the primer layer.

5. The coated automotive article of claim 4, wherein the base layer comprises a polycarbonate (PC) material.

6. The coated automotive article of claim 4, wherein the chlorinated polyolefin (CPO) resin comprises a non-volatile (NV) content of 15 to 25 wt %.

7. The coated automotive article of claim 4, wherein the modified polyester comprises a non-volatile (NV) content of 50 to 70 wt % and has a glass transition temperature (Tg) of 10 to 30° C.

8. A method of coating an automotive part, the comprising:
sequentially coating a base layer with a binder layer and a coating layer;
primarily heat-treating the coated base layer;
forming a printing layer comprising a laser pattern on the base layer;
secondarily heat-treating the printing layer;
sequentially coating the printing layer with a primer layer comprising a primer coating composition and a clear layer, wherein the primer coating composition comprises 20 to 25 wt % of a chlorinated polyolefin (CPO) resin having a weight-average molecular weight (Mw) of 50,000 to 100,000 g/mol, 2 to 4 wt % of a modified polyester, and 75 to 85 wt % of a hydrocarbon-based solvent; and
tertiarily heat-treating the coated printing layer.

9. The method of claim 8, wherein the binder layer comprises:
a main agent part comprising at least one selected from the group consisting of an acryl polyol, carbon black, a dispersant, a leveling agent, a wetting agent, a UV absorber, a catalyst, a ketone-based solvent, an ester-based solvent, and combinations thereof; and
a hardening agent part comprising hexamethylene diisocyanate trimer and an ester-based solvent.

10. The method of claim 9, wherein the main agent part and the hardening agent part of the binder layer are mixed in a weight ratio of 5 to 10:1.

11. The method of claim 8, wherein the coating layer comprises:
a main agent part comprising a color paint; and
a hardening agent part comprising hexamethylene diisocyanate trimer and an ester-based solvent.

12. The method of claim 11, wherein the main agent part and the hardening agent part of the coating layer are mixed in a weight ratio of 5 to 10:1.

13. The method of claim 8, wherein sequentially coating the base layer with the binder layer and the coating layer comprises:
applying the binder layer to a thickness of 8 to 10 μm; and
applying the coating layer to a thickness of 10 to 15 μm.

14. The method of claim 8, wherein primarily heat-treating the coated base layer is performed at a temperature of 70 to 90° C. for 20 to 60 minutes.

15. The method of claim 8, wherein the clear layer comprises:
a main agent part comprising at least one selected from the group consisting of an acryl polyol, a catalyst, a leveling agent, a wetting agent, a UV absorber, an ester-based solvent, a ketone-based solvent, a hydrocarbon-based solvent, a polyhydric alcohol derivative solvent, and combinations thereof; and
a hardening agent part comprising hexamethylene diisocyanate trimer and an ester-based solvent.

16. The method of claim 15, wherein the main agent part and the hardening agent part of the clear layer are mixed in a weight ratio of 2 to 5:1.

17. The method of claim 8, wherein secondarily heat-treating the printing layer is performed at a temperature of 110 to 140° C. for 30 to 60 minutes.

18. The method of claim 8, wherein sequentially coating the printing layer with the primer layer and the clear layer comprises:
applying the primer layer to a thickness of 4 to 6 μm; and
applying the clear layer to a thickness of 28 to 38 μm.

19. The method of claim 8, wherein tertiarily heat-treating the coated printing layer is performed at a temperature of 70 to 90° C. for 20 to 60 minutes.

20. The method of claim 8, wherein:
sequentially coating the base layer with the binder layer and the coating layer comprises:
applying the binder layer to a thickness of 8 to 10 μm; and
applying the coating layer to a thickness of 10 to 15 μm;
primarily heat-treating the coated base layer is performed at a temperature of 70 to 90° C. for 20 to 60 minutes;
secondarily heat-treating the printing layer is performed at a temperature of 110 to 140° C. for 30 to 60 minutes;
sequentially coating the printing layer with the primer layer and the clear layer comprises:
applying the primer layer to a thickness of 4 to 6 μm; and
applying the clear layer to a thickness of 28 to 38 μm; and
tertiarily heat-treating the coated printing layer is performed at a temperature of 70 to 90° C. for 20 to 60 minutes.
